(19) United States
(12) Patent Application Publication
(10) Pub. No.: US 2015/0212633 A1
(43) Pub. Date: Jul. 30, 2015

(54) TOUCH PANEL AND DISPLAY APPARATUS

(71) Applicant: SHARP KABUSHIKI KAISHA, Osaka (JP)

(72) Inventors: Shinji Yamagishi, Osaka (JP); Kazutoshi Kida, Osaka (JP); Yasuhiro Sugita, Osaka (JP)

(73) Assignee: Sharp Kabushiki Kaisha, Osaka (JP)

(21) Appl. No.: 14/416,233

(22) PCT Filed: Jun. 27, 2013
(86) PCT No.: PCT/JP2013/067619

§ 371 Date: Jan. 21, 2015

(30) Foreign Application Priority Data
Jul. 27, 2012 (JP) 2012-167667

(51) Int. Cl. G06F 3/041; G06F 3/045; G06F 3/044

(52) U.S. Cl. CPC G06F 3/0412; G06F 3/0416; G06F 3/044; G06F 3/045

(57) ABSTRACT

A touch panel having excellent detection sensitivity and response speed is provided with high reliability. This touch panel is provided with a first substrate, a second substrate, electrodes which detect the deformation amount of the second substrate, and first spacers and second spacers. The second spacers are provided in contact with both the substrates in a normal state, and the first spacers are lower than the second spacers, and the first spacers are provided on the first substrate and are separated from the second substrate in the normal state.

### TECHNICAL FIELD

The present invention relates to a touch panel, and a display device provided with the touch panel.

### BACKGROUND ART

In recent years, a display device in which a display part and an input part are integrated is widely used in order to miniaturize the device. Specifically, in mobile phones, Personal Digital Assistants (PDAs), laptop personal computers, or the like, a display device provided with a touch panel, which can detect a contact point when a finger or a pen for inputting contacts a display surface, is widely used (e.g., Patent Documents 1 to 3).

FIG. 17 is a cross-sectional view showing a schematic configuration of a dynamic quantity detection device (hereinafter referred to as touch panel) described in Patent Document 1.

The touch panel shown in FIG. 17 is provided with a base substrate 101, a displacement electrode 102, and an opposite electrode 103. The base substrate 101 is an elastic body, a part of which including the contact part or entirety of which including the contact part is deformed in response to a pressing force (load) by a contact object (detection object; finger) and is returned to an original shape when the pressing force is released by the contact object. The base substrate 101 is made of an elastomer. A plurality of displacement electrodes 102 are fixed on the surface or the inside of the base substrate 101, and at least one of the displacement electrodes is arranged in a deformation part (deformation area or displacement area) of the base substrate 101. The opposite electrode 103 is placed opposite from the displacement electrode 102 across the base substrate 101.

In this touch panel, when the base substrate 101 is deformed, the displacement electrode 102 follows the deformation and displacement in the deformation part without separating from the base substrate 101. A position of the contact object is detected by detecting a change in the electrostatic capacitance between the displacement electrode 102 and the electrode 103 based on the displacement of the displacement electrode 102.

### RELATED ART DOCUMENTS

### Patent Documents

Patent Document 1: Japanese Patent Application Laid-Open Publication No. 2011-17626 (publication date on Jan. 27, 2011)

Patent Document 2: Japanese Patent Application Laid-Open Publication No. 2010-33382 (publication date on Feb. 12, 2010)

Patent Document 3: Japanese Patent Application Laid-Open Publication No. 2012-89060 (publication date on May 10, 2012)

### SUMMARY OF THE INVENTION

### Problems to be Solved by the Invention

However, in the conventional touch panel shown in FIG. 17, the elastic body (base substrate 101) made of the elastomer is provided between the displacement electrode 102 and the opposite electrode 103 in a manner of corresponding to the entire surface of the electrode support 104 to which the object contacts. Therefore, a load (pressing force) of an area per unit to deform the base substrate 101 has to be increased. Further, in a case that the load is increased, when the pressing force is released, the time for recovery to an original state becomes longer. In the conventional touch panel, therefore, there are problems that the detection sensitivity is low and the response speed is slow. Further, there is a problem that the deformation amount of the base substrate 101 becomes large, and thus the strength (reliability) of the touch panel becomes low.

The present invention was made in the light of the aforementioned problems, and an object of the present invention is to provide a touch panel having excellent detection sensitivity and excellent response speed with high reliability, and a display device provided with the touch panel.

### Means for Solving the Problems

In order to solve the aforementioned problems, a touch panel according to the present invention includes: a first substrate; a second substrate arranged closer to a user side than the first substrate and facing the first substrate; a plurality of electrodes provided between the first substrate and the second substrate and detecting a deformation amount of the second substrate due to a load applied by a user; and a plurality of first spacers and a plurality of second spacers provided to keep a distance between the first substrate and the second substrate uniform; wherein the plurality of second spacers is provided in contact with the first substrate and the second substrate in a normal state in which the load is not applied to the second substrate, and wherein a height of each of the plurality of first spacers is less than each of the plurality of second spacers, and the plurality of first spacers is provided on one of the first substrate and the second substrate and is spaced from another one of the substrates in the normal state.

With such a configuration, in the normal state, a space (gap) is provided between the first spacer and one of the substrates. Therefore, when the load is applied to the touch panel, the second substrate is easily deformed as compared with the conventional touch panel (FIG. 17), therefore the detection sensitivity of the touch panel can be enhanced. Further, the elastic material does not exist between both of the substrates unlike in the conventional touch panel, thus when the load to the second substrate is released, the second substrate can easily return to the original state (normal state). Therefore, the response speed of the touch panel can be quicker than the conventional touch panel (FIG. 17). In addition, the deformation amount of the second substrate can be regulated because the first spacers exist. Thus, a breakage or the like of the second substrate can be prevented because the strength (reliability) of the touch panel can be secured.

In the aforementioned touch panel, a total projected area of the plurality of first spacers with respect to the first substrate can be larger than a total projected area of the plurality of second spacers with respect to the first substrate.

Therefore, the deformation amount of the second substrate can be regulated; therefore, the strength of the touch panel can be enhanced, and further, because the second substrate can easily deform, the detection sensitivity of the touch panel can be enhanced.

In the aforementioned touch panel, each of the plurality of first spacers can be formed as a layer and can be provided between the second spacers adjacent to each other.

In the aforementioned touch panel, the plurality of first spacers and the plurality of second spacers can be integrally formed.

With such a configuration, the manufacturing process of the touch panel can be simplified.

In the aforementioned touch panel, the heights of the respective first spacers can become progressively greater approaching a center position between the second spacers adjacent to each other.

With such a configuration, the deformation amount of the second substrate can be regulated nearly uniformly; thus, the strength (reliability) of the touch panel can be enhanced.

In the aforementioned touch panel, a configuration can be adopted in which a refractive index matching material is provided between the first substrate and the second substrate.

With such a configuration, when the touch panel is provided in a display device, the diffuse reflection of the light emitted from a display panel can be prevented. Therefore, the display quality can be enhanced.

In the aforementioned touch panel, the deformation amount can be detected based on a change in a resistance or a change in a capacitance between the plurality of electrodes

Therefore, with such a simple configuration, a position detection of a detection object can be surely performed.

In order to solve the aforementioned problems, a display device according to the present invention includes the aforementioned touch panel and a display panel provided on an opposite side from the user of the touch panel.

With such a configuration, the display device provided with the touch panel can be realized.

### Effects of the Invention

As described above, in the touch panel of the present invention, the plurality of second spacers are provided in contact with the first substrate or the second substrate in the normal state that the load is not applied to the second substrate, and the height of each of the plurality of first spacers is higher than the height of each of the plurality of second spacers, and the plurality of first spacers is provided on any one of the first substrate and the second substrate and is spaced from another one of the substrates in the normal state.

### BRIEF DESCRIPTION OF THE DRAWINGS

FIG. 1 is a cross-sectional view showing a schematic configuration of a touch panel according to Embodiment 1;

FIG. 2 is a schematic diagram showing a principle of a pressure detection method; FIG. 3 is a schematic diagram showing a principle of a touch detection method; FIG. 4 is a graph showing a change in signal strength with respect to a load in the pressure detection method and the touch detection method;

FIG. 5 is a schematic diagram showing a specific configuration of the pressure detection method;

FIG. 6 is a schematic diagram showing a specific configuration of the touch detection method;

FIG. 7 is a graph showing a relationship between the load and the signal strength in the touch panel according to Embodiment 1 and the conventional touch panel;

FIG. 8 is a graph showing a relationship between the load and the recovery time of the touch panel according to Embodiment 1 and the conventional touch panel;

FIG. 9 is a cross-sectional view showing another configuration of the touch panel according to Embodiment 1;

FIG. 10 is a cross-sectional view showing a schematic configuration of a touch panel according to Embodiment 2;

FIG. 11 is a diagram exemplifying a position detection method of the touch panel according to Embodiment 2;

FIG. 12 is a schematic diagram showing a planar structure of each electrode in the touch panel according to Embodiment 2;

FIG. 13 is a cross-sectional view showing a schematic configuration of a touch panel according to Modification Example 1;

FIG. 14 is a cross-sectional view showing a schematic configuration of a touch panel according to Modification Example 2;

FIG. 15 is a cross-sectional view showing a schematic configuration of a touch panel according to Modification Example 3;

FIG. 16 is a cross-sectional view showing a schematic configuration of a display device provided with the touch panel; and

FIG. 17 is a cross-sectional view showing a schematic configuration of a conventional touch panel.

### DETAILED DESCRIPTION OF EMBODIMENTS

Hereinafter, embodiments of the touch panel according to the present invention will be described in reference to the drawings.

### Embodiment 1

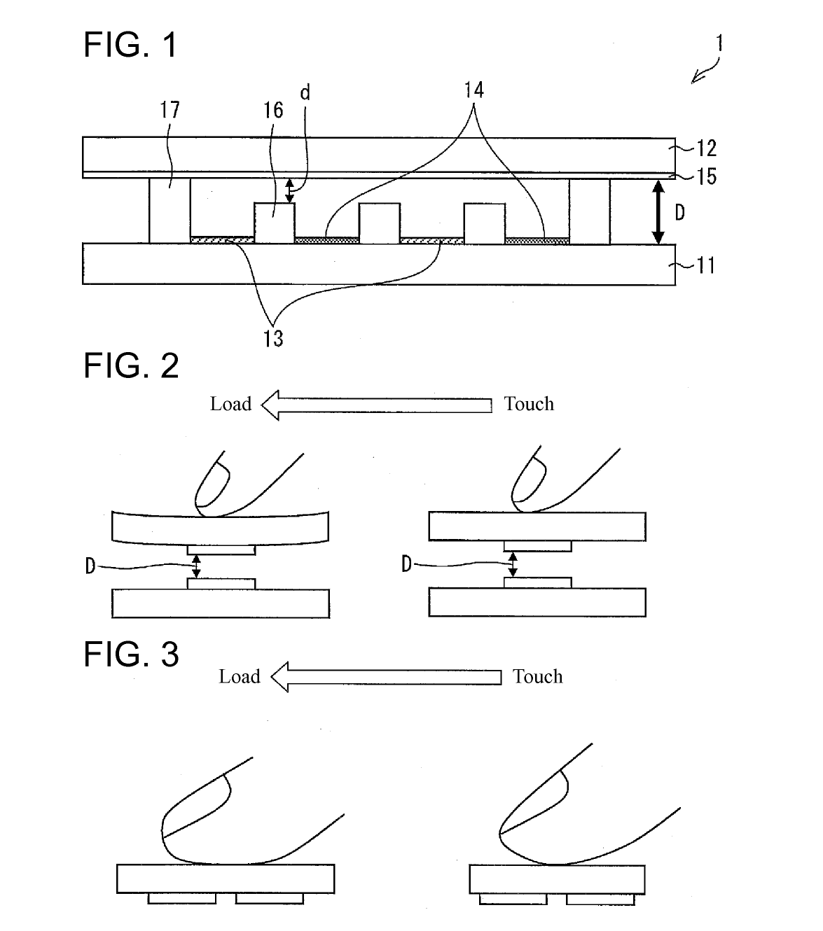

FIG. 1 is a cross-sectional view showing a schematic configuration of a touch panel according to the present embodiment. A touch panel 1 shown in FIG. 1 is provided with a pair of substrates (a first substrate 11 and a second substrate 12), a plurality of sensing electrodes 13 and drive electrodes 14 provided on the first substrate 11, a high resistance film 15 provided on the second substrate 12, and a plurality of first spacers 16 and second spacers 17 arranged between the substrates 11 and 12.

The first substrate 11 and the second substrate 12 are constituted of a transparent substrate and are made of a material that is strong against impact, such as glass, an acryl material, or the like, for example. The second substrate 12 is arranged on a user side and a detection object (finger, or the like) contacts the substrate; therefore, the second substrate 12 has a function as a protection member of the touch panel 1. The first substrate 11 is arranged on an opposite side (back surface side) of the user side, and when the touch panel 1 is provided in a display device, is the first substrate 11 is arranged to face the front surface of the display panel.

In the touch panel 1 according to the present embodiment, position detection of a detection object is performed by a pressure detection method. That is, as shown in FIG. 2, the position detection is performed based on a change in a distance D between the substrates 11 and 12 by applying the load. Therefore, variations in detection can be suppressed as compared with the touch detection method. FIG. 3 shows a principle of the position detection by the touch detection method. In the touch detection method, the position detection is performed based on a change in a contact area of the detection object (finger) with the load. In this method, variations in detection easily occur because there are variations in the size of fingers or the contact area of the substrate is limited. FIG. 4 is a graph showing a change in signal strength with respect to a load in the pressure detection method and the touch detection method. As shown in the graph, in the pressure detection method (the solid line in the graph of FIG. 4), the change in signal strength is more linear than in the touch detection method (the dotted line in the graph of FIG. 4), and it is understood that there are less variations caused by the size of fingers.

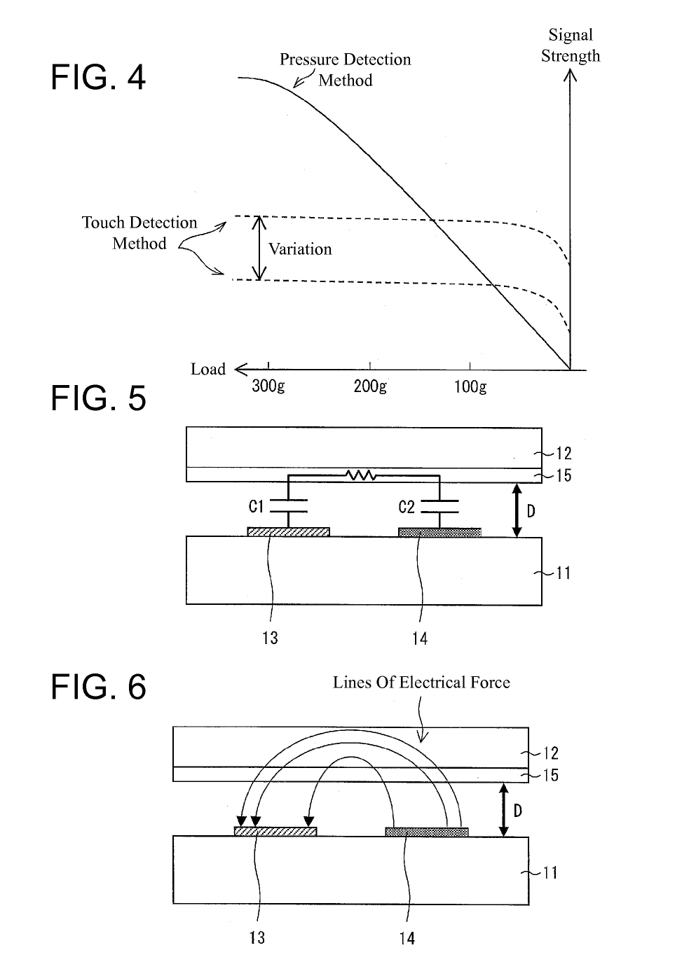

More specifically, in the pressure detection method, a change in a distance D between the substrates 11 and 12 is detected by the sensing electrode 13 and the drive electrode 14 based on a change in capacitances C1 and C2 shown in FIG. 5.

In the touch panel 1, the pressure detection method and the touch detection method may be used in combination. In the touch detection method, the change in the distance D between the substrates 11 and 12 is detected by the sensing electrode 13 and the drive electrode 14 based on the change in the line of electric force shown in FIG. 6, that is, the change in the electrostatic capacitance. That is, the touch panel 1 performs a detection operation by switching the pressure detection method of low frequency driving (tens of kHz) and the touch detection method of high frequency driving (hundreds of kHz) by the time-division system of the drive frequency. Therefore, the detection accuracy can be enhanced.

The position detection method in the touch panel 1 is not limited, and a well-known method can be applied. For example, an electrostatic capacitance method may be applied.

The first spacers 16 and the second spacers 17 are the components to keep the distance between the substrates 11 and 12, and it is preferable that the material be a photo-curable resin, have high transparency, and be made of, for example, acrylic photo-curable material. As shown in FIG. 1, in a normal state in which the load (pressing force) is not applied to the touch panel 1, the second spacers 17 are provided in contact with the first substrate 16 and the second substrate 17 so that the distance D between the substrates 16 and 17 is kept. The first spacers 16 are provided on the first substrate 11, and the height thereof is less than the second spacers 17 so that the first spacers are separated from the second substrate 12 at a distance d in the normal state. The number of the first spacers 16 is greater than the number of the second spacers 17, and the first spacers 16 are arranged at a higher density.

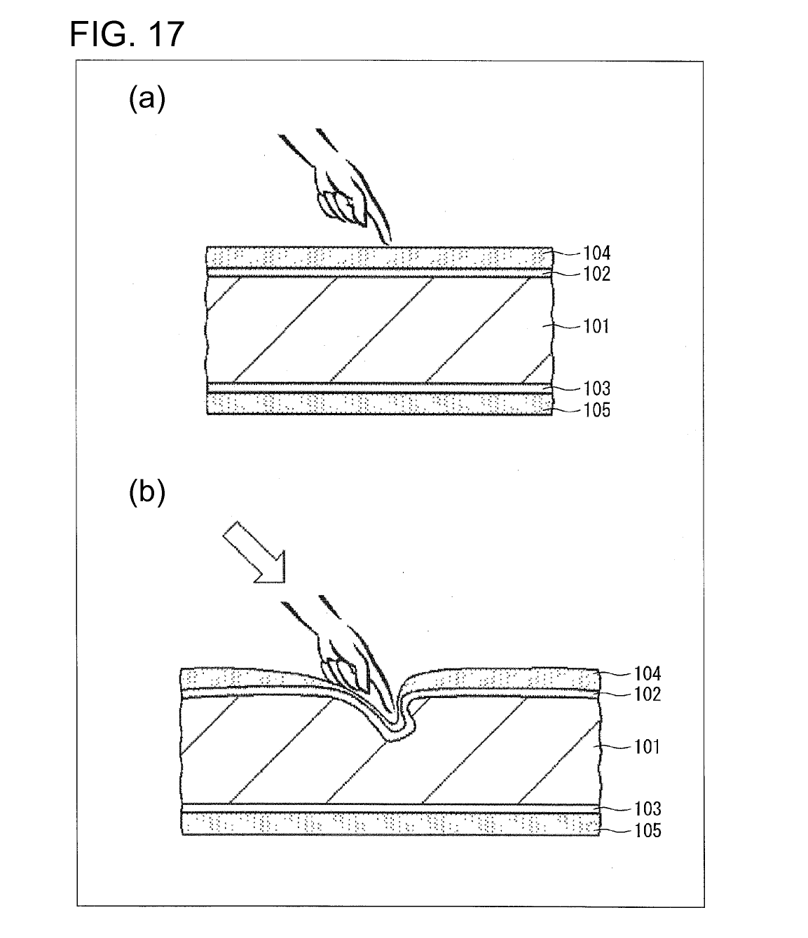

According to the aforementioned configuration, in the normal state, a space (gap) is formed in the distance d between the first spacers 16 and the second substrate 12, and the second substrate 12 is easily deformed when the load is applied. Therefore, the detection sensitivity of the touch panel can be enhanced as compared to the conventional touch panel (FIG. 17). Further, since the elastic material does not exist between the substrates 11 and 12 unlike in the conventional touch panel, when the load is released from the second substrate 12, the second substrate 12 can easily return to the original state (normal state). Therefore, the response speed of the touch panel can be quicker than the conventional touch panel (FIG. 17). Further, the deformation amount of the second substrate 12 can be regulated within the distance d because the first spacers 16 exist. Therefore, the strength (reliability) of the touch panel 1 can be secured because the breakage or the like of the second substrate 12 can be prevented.

Therefore, the touch panel 1 can be made larger because it has high reliability. Accordingly, the touch panel 1 is preferably used for a large display device.

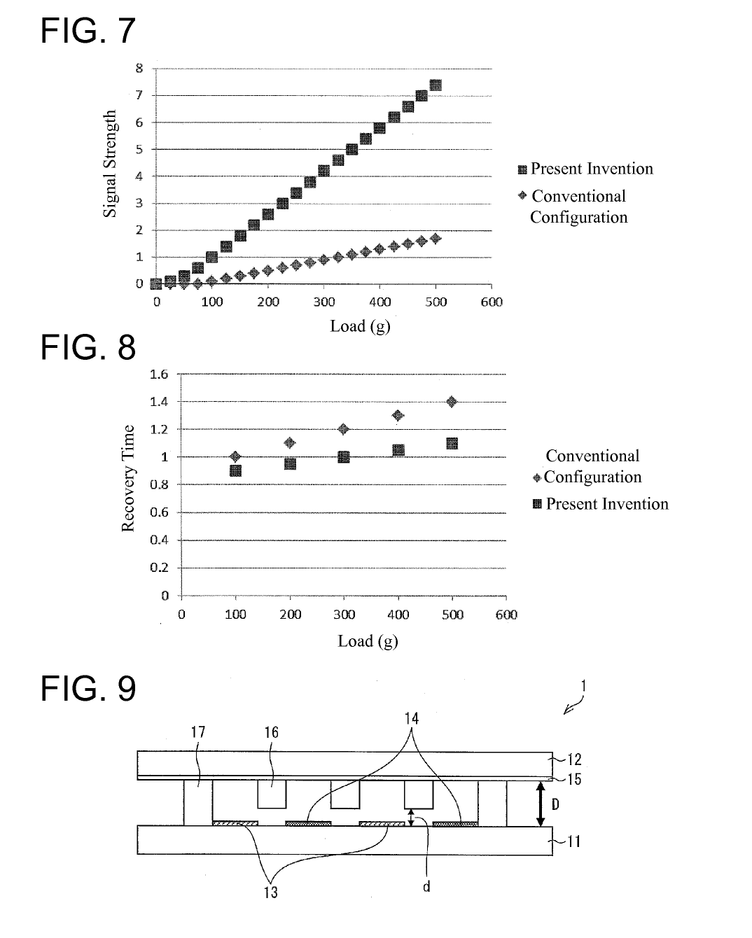

FIG. 7 is a graph showing a relationship between the load (applied load) and the signal strength in the touch panel 1 according to the present embodiment and the conventional touch panel. As shown in the graph, the signal strength with respect to the load in the touch panel 1 according to the present embodiment (“present invention” in the graph of FIG. 7) is larger than the conventional touch panel (“conventional configuration” in the graph of FIG. 7). That is, the touch panel 1 has higher detection sensitivity than the conventional touch panel.

FIG. 8 is a graph showing a relationship between the load (applied load) and the time in which the touch panel returns to the original state (recovery time) in the touch panel 1 according to the present embodiment and the conventional touch panel. The graph indicates a ratio when the recovery time is defined as 1 and the load applied in the conventional touch panel is 100 g. As shown in the graph, it is understood that the recovery time with respect to the load in the touch panel 1 according to the present embodiment (“the present invention” in the graph of FIG. 8) is shorter than the recovery time with respect to the load in the conventional touch panel (“conventional configuration” in the graph of FIG. 8). That is, it is understood that the response speed in the touch panel 1 is quicker than the conventional touch panel (excellent response characteristics).

Here, the first spacers 16 and the second spacers 17 are arranged in response to the desired strength and detection sensitivity of the touch panel 1. Specifically, the first spacers 16 are arranged at a high density (dense), and the second spacers 17 are arranged at a low density (sparse). In other words, the plurality of first spacers 16 and the second spacers 17 are arranged such that a total projected area of the plurality of first spacers 16 with respect to the first substrate 11 is larger than a total projected area of the plurality of second spacers 17 with respect to the first substrate 11. Therefore, the deformation amount of the second substrate 12 can be regulated, and thus the strength of the touch panel 1 can be enhanced. In addition, the second substrate 12 can be easily deformed, which allows the detection sensitivity of the touch panel 1 to be enhanced.

The shapes of the first spacers 16 and the second spacers 17 are not limited, and various shapes such as a column shape, a spherical shape, a conical shape, a pyramid shape, or the like can be formed.

Further, as shown in FIG. 9, the first spacers 16 may be provided on the second substrate 12.

### Embodiment 2

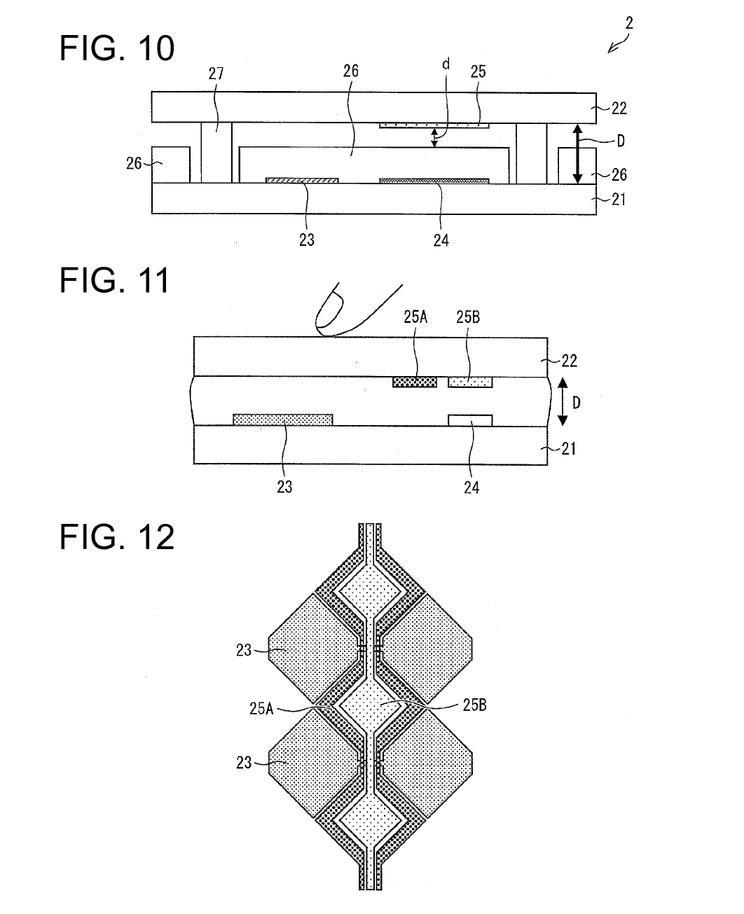

FIG. 10 is a cross-sectional view showing a schematic configuration of the touch panel according to the present embodiment. As shown in FIG. 10, a touch panel 2 is provided with a pair of substrates (a first substrate 21 and a second substrate 22), a plurality of sensing electrodes 23 and force electrodes 24 provided on the first substrate 21, a plurality of drive electrodes 25 provided on the second substrate 22, and a plurality of first spacers 26 and second spacers 27 arranged between the substrates 21 and 22.

The first substrate 21 and the second substrate 22 are configured by a transparent substrate and are made of a material that is strong against impact, such as a glass material, an acryl material, or the like. The second substrate 22 is arranged on the user side and a detection object (finger, or the like) contacts the substrate, and thus the second substrate 22 has a function as a protection member of the touch panel 2. The first substrate 21 is arranged on an opposite side of the user side, and when the touch panel 2 is provided in a display device, it is arranged to face the front surface of the display panel.

In the touch panel 2 according to the present embodiment, position detection of a detection object is performed by the pressure detection method and the touch detection method. That is, as shown in FIG. 11, the position detection is performed based on a change in the distance D and a change in the electrostatic capacitance between the substrates 21 and 22 by applying a load. FIG. 12 shows a schematic diagram showing a planar structure of each electrode (sensing electrodes 23, drive electrodes 25A and 25B). The sensing electrodes 23 are used for touch detection, and the force electrodes 24 are used for pressure detection.

The first spacers 26 and the second spacers 27 are the components to keep the distance between both the substrates 21 and 22, and it is preferable that the material be a photo-curable resin, have high transparency, and be made of, for example, acrylic photo-curable material. As shown in FIG. 10, in a normal state in which the load (pressing force) is not applied to the touch panel 2, the second spacers 27 are provided in contact with the first substrate 26 and the second substrate 27 so that the distance D between the substrates 26 and 27 is kept. The first spacers 26 are provided on the first substrate 21 as a layer, and the height thereof is less than the second spacers 27 so that they are separated from the second substrate 22 (the drive electrode 25) at a distance d in the normal state. The first spacers 26 are provided between the second spacers 27, which are adjacent to each other.

According to the aforementioned configuration, in the normal state, a space (gap) is formed in the distance d between the first spacers 26 and the second substrate 22, and the second substrate 22 is easily deformed when the load is applied. Therefore, the detection sensitivity of the touch panel can be enhanced in comparison with the conventional touch panel (FIG. 17). Further, since the elastic material does not exist between the substrates 21 and 22 unlike the conventional touch panel, when the load is released from the second substrate 22, the second substrate 22 can easily return to the original state (normal state). Therefore, the response speed of the touch panel can be quicker than the conventional touch panel (FIG. 17). Further, the deformation amount of the second substrate 22 can be regulated within the distance d because the first spacers 26 exist. Therefore, the strength of the touch panel 2 can be secured because the breakage or the like of the second substrate 22 can be prevented. Further, the first spacers 26 are formed as a layer; thus, the strength and reliability of the touch panel 2 can be more enhanced as compared with the touch panel 1 according to Embodiment 1.

According to the touch panel 2 of the present embodiment, the detection sensitivity and the response speed can be enhanced in the same manner as the touch panel 1 (FIGS. 7 and 8) according to Embodiment 1. In addition, the touch panel 2 has high reliability, so it is preferably used in a large sized display device.

The shapes of the first spacers 26 and the second spacers 27 are not limited, and various shapes such as a column shape, a spherical shape, a conical shape, a pyramid shape, or the like can be formed in the same manner as Embodiment 1. Further, the first spacers 26 may be provided on the second substrate 22.

Further, the plurality of first spacers 26 and the second spacers 27 are arranged such that a total projected area of the plurality of first spacers 26 with respect to the first substrate 21 is larger than a total projected area of the plurality of second spacers 27 with respect to the first substrate 21.

### MODIFICATION EXAMPLE 1

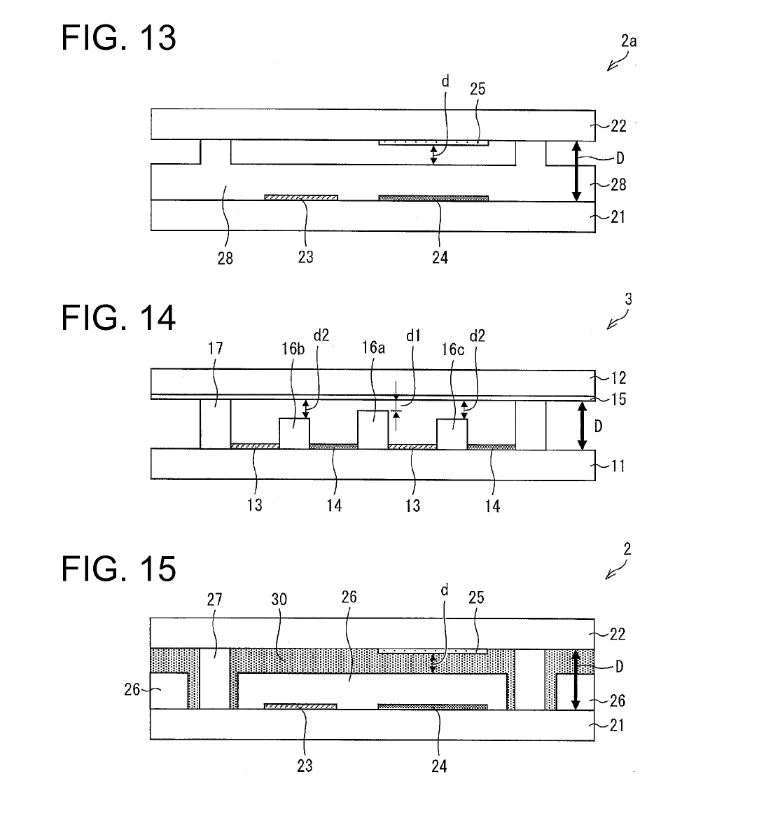

In the touch panel 2 according to Embodiment 2, the first spacers 26 and the second spacers 27 may be integrally formed. FIG. 13 is a cross-sectional view showing a schematic configuration of a touch panel 2a according to Modification Example 1. The integrated structure of the spacer 28 can be formed by, for example, a photolithographic method, and the height difference can be formed by one-time exposure by using, for example, a halftone mask, or the like. With such a configuration, the same effects as the touch panel 2 according to Embodiment 2 can be obtained, and the manufacturing process of the touch panel 2 can be simplified.

### MODIFICATION EXAMPLE 2

In the touch panels 1, 2, and 2a according to Embodiments 1 and 2, the deformation amount of the second substrate when the load is applied to the second substrate is substantially changed in response to the position (contact point) where the load is applied. Specifically, the deformation amount (bending amount) of the second substrate becomes larger approaching an intermediate position between the second spacers adjacent to each other.

In a touch panel 3 according to Modification Example 2, a height of the first spacers (16, 26) becomes higher approaching an intermediate position between the second spacers (17, 27) adjacent to each other. For example, as shown in FIG. 14, the height d1 of the first spacer 16a located in the intermediate position between the second spacers 17, which are adjacent to each other, is higher than the height d2 of the first spacers 16b and 16c adjacent to the first spacer 16a. The difference in height among the first spacers can be formed by one-time exposure by using, for example, a halftone mask, or the like.

Therefore, the deformation amount of the second substrate 12 in the approximate intermediate position between the second spacers 17, which are adjacent to each other, can be suppressed. That is, regardless of the position (contact point) where the load is applied, the deformation amount of the second substrate 12 can be regulated nearly uniformly. Therefore, the strength (reliability) of the touch panel can be enhanced.

### MODIFICATION EXAMPLE 3

In each of the aforementioned touch panels, a refractive index matching material may be provided between the first substrate and the second substrate. As an example, FIG. 15 shows a state in which a refractive index matching material 30 is provided between the first substrate 21 and the second substrate 22 in the touch panel 2.

With such a configuration, when the touch panel is provided in the display device, the diffuse reflection of the light emitted from the display panel can be prevented, and thus, the display quality can be enhanced.

<Display Device>

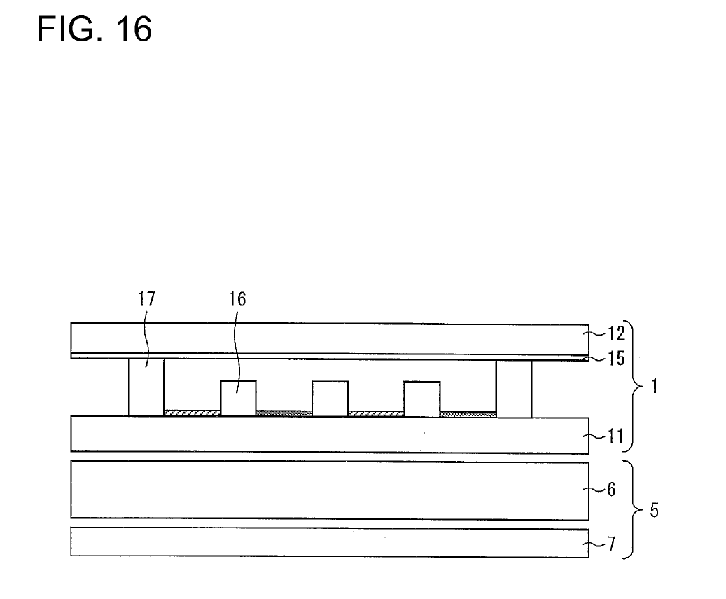

Each of the aforementioned touch panels can be provided in a display device. As an example, FIG. 16 shows a schematic configuration of a display device 5 that is provided with the touch panel 1 according to Embodiment 1.

A display panel 6 is arranged in a manner facing the back surface (the first substrate 11) of the touch panel 1, and a backlight 7 is provided on the back surface of the display panel 6. Therefore, the display device 5 provided with the touch panel can be realized. As for the display device 5, various display devices such as a liquid crystal display device, an organic EL display device, a plasma display, or the like can be applied.

The present invention is not limited to the aforementioned embodiments, but may be altered within the scope of the claims. An embodiment based on a proper combination of technical means disclosed in different embodiments is encompassed in the technical scope of the present invention.

### INDUSTRIAL APPLICABILITY

The touch panel of the present invention can be used in various display devices.

### DESCRIPTION OF REFERENCE CHARACTERS

1, 2, 2a touch panel

11, 21 first substrate

12, 22 second substrate

13, 23 sensing electrode (electrode)

14, 25 drive electrode (electrode)

15 high resistance film

16, 26 first spacer

17, 27 second spacer

24 force electrode (electrode)

28 spacer

30 refractive index matching material

1. A touch panel comprising:
a first substrate;
a second substrate arranged closer to a user side than said first substrate and facing said first substrate;
a plurality of electrodes provided between said first substrate and said second substrate and detecting a deformation amount of said second substrate due to a load applied by a user; and
a plurality of first spacers and a plurality of second spacers provided to keep a distance between said first substrate and said second substrate uniform;
wherein said plurality of second spacers is provided in contact with said first substrate and said second substrate in a normal state in which the load is not applied to said second substrate, and
wherein a height of each of said plurality of first spacers is less than each of said plurality of second spacers, and said plurality of first spacers is provided on one of said first substrate and said second substrate and is spaced from another one of said substrates in the normal state.

2. The touch panel according to claim 1, wherein a total projected area of said plurality of first spacers with respect to said first substrate is larger than a total projected area of said plurality of second spacers with respect to the first substrate.

3. The touch panel according to claim 1, wherein each of said plurality of first spacers is formed as a layer and is provided between said second spacers adjacent to each other.

4. The touch panel according to claim 1, wherein said plurality of first spacers and said plurality of second spacers are integrally formed.

5. The touch panel according to claim 1, wherein the heights of the respective first spacers become progressively greater approaching a center position between the second spacers adjacent to each other.

6. The touch panel according to claim 1, further comprising: a refractive index matching material provided between said first substrate and said second substrate.

7. The touch panel according to claim 1, wherein the deformation amount is detected based on a change in a resistance or a change in a capacitance between said plurality of electrodes.

8. A display device comprising:
said touch panel according to claim 1; and
a display panel provided on an opposite side from the user of said touch panel.

9. The touch panel according to claim 2, further comprising: a refractive index matching material provided between said first substrate and said second substrate.

10. The touch panel according to claim 3, further comprising: a refractive index matching material provided between said first substrate and said second substrate.

11. The touch panel according to claim 4, further comprising: a refractive index matching material provided between said first substrate and said second substrate.

12. The touch panel according to claim 5, further comprising: a refractive index matching material provided between said first substrate and said second substrate.

13. The touch panel according to claim 2, wherein the deformation amount is detected based on a change in a resistance or a change in a capacitance between said plurality of electrodes.

14. The touch panel according to claim 3, wherein the deformation amount is detected based on a change in a resistance or a change in a capacitance between said plurality of electrodes.

15. The touch panel according to claim 4, wherein the deformation amount is detected based on a change in a resistance or a change in a capacitance between said plurality of electrodes.

16. The touch panel according to claim 5, wherein the deformation amount is detected based on a change in a resistance or a change in a capacitance between said plurality of electrodes.

17. The touch panel according to claim 6, wherein the deformation amount is detected based on a change in a resistance or a change in a capacitance between said plurality of electrodes.

18. The touch panel according to claim 9, wherein the deformation amount is detected based on a change in a resistance or a change in a capacitance between said plurality of electrodes.

19. The touch panel according to claim 10, wherein the deformation amount is detected based on a change in a resistance or a change in a capacitance between said plurality of electrodes.

20. The touch panel according to claim 11, wherein the deformation amount is detected based on a change in a resistance or a change in a capacitance between said plurality of electrodes.
